(19) United States
(12) Patent Application Publication
(10) Pub. No.: US 2019/0111851 A1
(43) Pub. Date: Apr. 18, 2019

(54) GOLF CART DASH LINER

(71) Applicant: JAMES F. WALTERS, CHARLOTTE, NC (US)

(72) Inventor: JAMES F. WALTERS, CHARLOTTE, NC (US)

(21) Appl. No.: 16/159,247

(22) Filed: Oct. 12, 2018

Related U.S. Application Data
(60) Provisional application No. 62/572,049, filed on Oct. 13, 2017.

(51) Int. Cl. B60R 7/06; A63B 55/60

(52) U.S. Cl. CPC B60R 7/06; A63B 55/61

(57) ABSTRACT

An improved golf cart dash liner adapted to be placed in a golf cart receptacle to improve the visibility and retention of items therein, the liner having a light color, a moisture-resistant non-slip upper surface, and a non-slip lower surface.

### CROSS REFERENCE TO RELATED APPLICATION

This application claims the benefit of priority of U.S. Provisional Patent Application Ser. No. 62/572,049, filed Oct. 13, 2017.

### FIELD OF THE INVENTION

The present invention relates to an article of manufacture and the use of the same, and more particularly to a liner for use in the dashboard recesses of a golf cart to increase the visibility of objects therein. The invention also comprehends providing a Golf Cart Dash Liner in a dark dashboard recess to provide a light color base so objects can be more easily seen in the dark cavities of a golf cart dashboard.

### BACKGROUND OF THE INVENTION

There are many models of golf carts, and many dashboard configurations, most with recesses or compartments having a variety of compartment configurations, sizes, and shapes. The invented recess liner may be cut or adapted to mate with any such recess configuration.

Upon the conclusion of a golf game, when a golfer does not see and retrieve his or her personal property from a golf cart that the golfer has been using, and then leaves the golf course, an extensive amount of time is often spent later in an attempt to locate the owner of the personal property, if found by the cart cleaning crew. If the property is overlooked or missed by the cart cleaning crew, then each cart and every cavity must be searched later when the golfer calls to retrieve his lost property. Often this requires searching in as many as 70 or even more carts that might have been in use on a particular day.

It is also desirable to inhibit the tendency of items placed in a dashboard recess to bounce out of the recess or to move about within the recess.

### SUMMARY OF THE INVENTION

The invention is a dash recess liner that is placed in a golf cart dashboard recess and provides a means of making items placed in or left in the dash recess more visible than currently, and reduces the incidents of golfers losing their personal property, such as keys, wallet, phone, range finder, glasses, etc. In addition, the invented dash recess liner is water-resistant, stain resistant, easy to clean, lightweight, and has a non-slip or light tack surface to provide “grip” to items placed thereon. The surface may be textured.

The invented dash liner has a light color base so objects can be easily seen in the dark, often black, cavities of the golf cart dashboard when the liner is used. Preferred colors are gray, tan of various hues, or white.

The invented dash liner may be provided with one or more mating holes or notches to match with drain holes in the golf cart dashboard recess.

### OBJECTS OF THE INVENTION

The principal object of the present invention is to provide an improved means of increasing the visibility of items in a golf cart dash board.

A further object of this invention is to provide a device for cushioning items placed in a golf cart dash board or the like.

Another object of this invention is to provide a device for insertion into a cavity which is easy to install and remove, yet which will stay in place during use and operation of, and washing of a golf cart.

Another object of this invention is to provide a device for placement into a dashboard recess of a golf cart that is durable, water-resistant, stain resistant, easy to clean, lightweight, and has a surface which provides “grip” to items placed thereon.

Another object of this invention is to provide a device for placement into a dashboard recess of a golf cart that will pass safety tests for lead migration, and for color fastness.

### BRIEF DESCRIPTION OF THE DRAWINGS

The foregoing and other objects will become more readily apparent by referring to the following detailed description and the appended drawings, which are not to scale, in which:

FIG. 1 is a top view of a golf cart dashboard recess liner which is adapted to fit in and mate with a dash recess.

FIG. 2 is a right side view of the golf cart dashboard recess liner of FIG. 1.

FIG. 3 is a top view of an alternative golf cart dashboard recess liner which is adapted to fit in and mate with a dash recess.

FIG. 4 is a right side view of the golf cart dashboard recess liner of FIG. 3.

FIG. 5 is a top view of another alternative golf cart dashboard recess liner which is adapted to fit in and mate with a dash recess.

FIG. 6 is a right side view of the golf cart dashboard recess liner of FIG. 5.

FIG. 6A is an enlarged side view of a portion of the golf cart dashboard liner of FIGS. 5 and 6.

### DETAILED DESCRIPTION

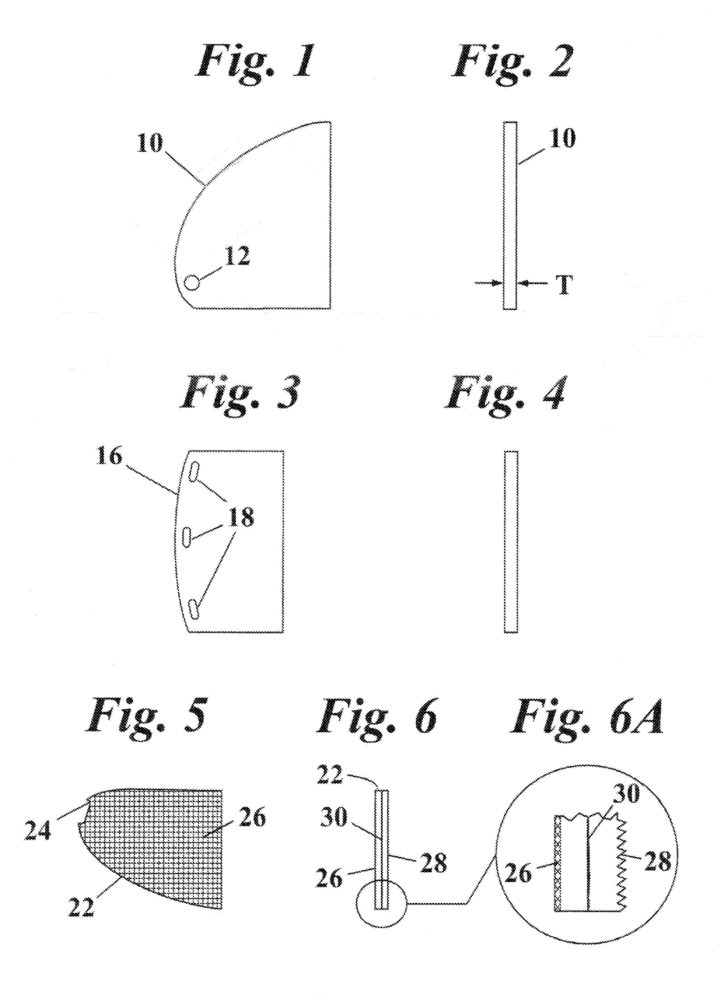

Referring now to FIG. 1, the invented liner 10 is a light color on which objects are easily visible, and is adapted to fit closely into a dash recess, one or more holes 12 therein being provided to mate with a corresponding drain hole in the dash of a golf cart in which it will be installed. FIG. 2 shows the thickness T of the liner 10, which is preferably from ⅛ inch to 5/32 inch. The top of liner is sufficiently light in color enough to create contrast between personal items placed in dash compartment and the liner. Preferable colors for the top of the liner are gray, tan, and white. The top and bottom of the liner may be the same color.

FIG. 3 shows a recess liner of different configuration from that of FIG. 1, with different hole placement 18 to mate with drain holes in the dashboard recess in which it is installed. The alternative liner of FIG. 5 shows a notch 24 to mate with a corner drain hole of a golf cart dash recess.

The top or upper face of the liner is moisture resistant to allow water to flow over the liner into the drainage holes with which the hole or holes in the liner are mated, which will differ according to the golf cart dash configuration. Either the upper surface or an intermediate layer may be cushioned, such as provided by a premium grip shelf liner. The bottom face of the liner has a non-slip surface, and may be rubberized, if desired.

The liner is easily cut to the dimensions of the bottom of the dash recess. The liner is made into various shapes to match the shape of each different golf cart manufacturer's dashboard cavities. The liner is installed by simply placing it into the mating dashboard recess with the hole or holes, notch or notches, mating with the drain hole or holes in the recess. The liner stays in place and does not move around when the cart is in operation because of the non-slip bottom surface. The liner material is preferably soft enough to cushion items resting on the top of the liner and limit bouncing of such items. The top also creates “grip” on items placed on liner to limit sliding around on the liner in the compartment. The bottom of the liner likewise creates “grip” to keep liner in place in compartment. Since it is not fixed in place, it is easily removed for cleaning by lifting, yet the non-slip bottom surface of the liner prevents it from being washed out of the cart when being cleaned by golf course personnel, or by a private owner of the golf cart.

The preferred material for the invented liner is flexible PVC (polyvinyl chloride) which has been treated with a plasticizer to provide a tacky upper surface and lower surface. Advantageously, the liner may have an intermediate scrim layer or embedded fabric mesh 30 to provide strength, durability, and resistance from tearing. The upper surface may advantageously have a waffle top pattern 26 or a pebbled surface to aid in holding items thereon. The bottom surface may be similar to the top but may be provided with small parallel ribs 28 in the bottom face for establishing grip to the recess. The material can be readily cut by a laser or by standard metal stamping dies.

ASTM F963 has long been a key standard for toy safety testing regarding migration of certain toxic metal elements. This standard addresses safety requirements for toys which are any object designed, manufactured or marketed as a plaything for children under 14 years of age. Although powered Land Vehicles are excluded from this standard, the present invention meets this standard.

The invented liner also meets the following standards for color fastness:
Color fastness to rubbing: BS EN ISO 105-X12:1995
Color fastness to water: BS EN ISO 105-X12:1995

The liner is easy to clean. When a liner has become messy, it is removed with the trash on it and dumped. If any material stays on the liner after dumping, it is shaken, or material removed by brushing. If any material is still on the liner, it is sprayed with a hose or pressure washer and returned to the recess. It has been found that chocolate, ketchup, salsa, BBQ sauce, mayonnaise, yogurt, pimento cheese, and Coke are all easily washed off the liner. However, mustard is removed by soaking the liner—stain down—in a container, such as a sink or plastic tub, with two quarts (½ gallon) of water and about 4 ounces of bleach for about 15 minutes then rinsing it thoroughly and rubbing it dry.

### SUMMARY OF THE ACHIEVEMENT OF THE OBJECTS OF THE INVENTION

From the foregoing, it is readily apparent that I have invented an improved method and means of increasing the visibility of items in a golf cart dash board, as well as an improved article of manufacture for cushioning and retaining items placed in a golf cart dash board or the like.

It is to be understood that the foregoing description and specific embodiments are merely illustrative of the best mode of the invention and the principles thereof, and that various modifications and additions may be made to the apparatus by those skilled in the art, without departing from the spirit and scope of this invention.

What is claimed is:

1. An article of manufacture, comprising a liner made of a flexible PVC material, which is adapted to be placed in a receptacle, said liner having a light color upper surface, a moisture-resistant non-slip upper surface, and a non-slip lower surface.

2. An article of manufacture according to claim 1, wherein said liner has an intermediate scrim or embedded fabric mesh layer between said upper surface and said lower surface.

3. An article of manufacture according to claim 1, wherein the color of said upper surface is gray, tan, or white.

4. An article of manufacture according to claim 1 wherein said liner is provided with one or more drain mating holes or notches.

5. An article of manufacture according to claim 1 wherein said liner upper surface has a raised pattern thereon.

6. An article of manufacture according to claim 5 wherein said raised pattern is a waffle pattern.

7. An article of manufacture according to claim 1 wherein said liner upper surface is pebbled.

8. An article of manufacture according to claim 1 wherein said liner lower surface has a ribbed bottom face.

9. An article of manufacture according to claim 1 wherein said liner has a thickness of from ⅛ inch to 5/32 inch.

10. An article of manufacture according to claim 1 wherein said liner meets ASTM Standard F963 regarding migration of certain toxic metal elements.

11. An article of manufacture according to claim 1 wherein said liner meets the following standards for color fastness:
Color fastness to rubbing: BS EN ISO 105-X12:1995
Color fastness to water: BS EN ISO 105-X12:1995.

12. A method of highlighting objects to improve their visibility in a dark recess by providing a liner made of a flexible material, which is adapted to be placed into such dark recess, said liner having a light upper surface color, a moisture-resistant, non-slip upper surface, and a non-slip lower surface.
